(19) United States
(12) Patent Application Publication
(10) Pub. No.: US 2026/0027984 A1
(43) Pub. Date: Jan. 29, 2026

(54) IN-VEHICLE SYSTEM AND ECU

(71) Applicants: AutoNetworks Technologies, Ltd., Yokkaichi-shi (JP); Sumitomo Wiring Systems, Ltd., Yokkaichi-shi (JP); Sumitomo Electric Industries, Ltd., Osaka (JP); Toyota Jidosha Kabushiki Kaisha, Toyota-shi (JP)

(72) Inventors: Yuki SANO, Yokkaichi-shi (JP); Yuta TANINAKA, Yokkaichi-shi (JP); Takuma YAMANE, Yokkaichi-shi (JP); Ryutaro YAMAZAKI, Toyota-shi (JP)

(73) Assignees: AutoNetworks Technologies, Ltd., Yokkaichi-shi (JP); Sumitomo Wiring Systems, Ltd., Yokkaichi-shi (JP); Sumitomo Electric Industries, Ltd., Osaka (JP); Toyota Jidosha Kabushiki Kaisha, Toyota-shi (JP)

(21) Appl. No.: 19/278,867

(22) Filed: Jul. 24, 2025

(30) Foreign Application Priority Data
Jul. 26, 2024 (JP) 2024-120696

(51) Int. Cl. B60R 16/03; B60R 16/023

(52) U.S. Cl. CPC B60R 16/03; B60R 16/0231

(57) ABSTRACT

An in-vehicle system includes an ECU mounted on a vehicle and an in-vehicle management device capable of communicating with the ECU. When the start condition is satisfied, the in-vehicle management device switches the relay that switches the power supply state to the ECU, to the ON state, and transmits the start instruction signal to the ECU. When the relay is switched to the ON state, the ECU receives power supply and switches from the power-OFF state to the active state. The ECU maintains the active state when receiving the start instruction signal within the determination time after having switched to the active state, and transmits the shut-off permission signal to the in-vehicle management device when not receiving the start instruction signal within the determination time. When receiving the shut-off permission signal, the in-vehicle management device switches the relay to the OFF state.

### CROSS-REFERENCE TO RELATED APPLICATIONS

This application claims priority of Japanese Patent Application No. 2024-120696, filed on Jul. 26, 2024, the content of which is incorporated herein.

### TECHNICAL FIELD

The present disclosure relates to an in-vehicle system and an ECU.

### BACKGROUND

Japanese Patent Application Laid-Open No. 2013-192108 discloses a configuration in which a switch is provided between a battery and an ECU.

In the configuration of Japanese Patent Application Laid-Open No. 2013-192108, the ECU can be switched between a power-OFF state and a power-ON state by switching the ON/OFF state of the switch. However, in the configuration of Japanese Patent Application Laid-Open No. 2013-192108, even when the switch is erroneously switched to the ON state, the ECU is switched to the power-ON state, and thus there is a concern that the ECU may wastefully consume power.

The present disclosure provides a technique that can easily reduce wasteful power consumption of an ECU.

### SUMMARY

An in-vehicle system of the present disclosure includes: an ECU mounted on a vehicle, and an in-vehicle management device capable of communicating with the ECU, wherein when a start condition is satisfied, the in-vehicle management device switches a relay that switches a power supply state to the ECU, to an ON state, and transmits a start instruction signal to the ECU, when the relay is switched to the ON state, the ECU receives power supply and switches from a power-OFF state to an active state, the ECU maintains the active state when receiving the start instruction signal within a determination time after having switched to the active state, and transmits a shut-off permission signal to the in-vehicle management device when not receiving the start instruction signal within the determination time, and when receiving the shut-off permission signal, the in-vehicle management device switches the relay to an OFF state.

An ECU of the present disclosure is configured to switch to an active state when receiving power supply, maintain the active state when receiving a start instruction signal from an in-vehicle management device within a determination time after having switched to the active state, and shift to a sleep state when not receiving the start instruction signal within the determination time.

According to the technique of the present disclosure, wasteful power consumption of the ECU can be easily reduced.

### BRIEF DESCRIPTION OF THE DRAWINGS

FIG. 1 is a configuration diagram schematically illustrating an in-vehicle system of a first embodiment;

FIG. 2 is a flowchart illustrating a flow of processing performed by an in-vehicle management device of the first embodiment; and

FIG. 3 is a flowchart illustrating a flow of processing performed by an ECU of the first embodiment.

### DETAILED DESCRIPTION OF PREFERRED EMBODIMENTS

First, embodiments of the present disclosure will be listed and described.

In a first aspect, an in-vehicle system includes: an ECU mounted on a vehicle, and an in-vehicle management device capable of communicating with the ECU, in which when a start condition is satisfied, the in-vehicle management device switches a relay that switches a power supply state to the ECU, to an ON state, and transmits a start instruction signal to the ECU, when the relay is switched to the ON state, the ECU receives power supply and switches from a power-OFF state to an active state, the ECU maintains the active state when receiving the start instruction signal within a determination time after having switched to the active state, and transmits a shut-off permission signal to the in-vehicle management device when not receiving the start instruction signal within the determination time, and when receiving the shut-off permission signal, the in-vehicle management device switches the relay to an OFF state.

The in-vehicle system can supply power to the ECU by switching the relay to the ON state when the start condition is satisfied, and can switch the ECU from the power-OFF state to the active state. Furthermore, the in-vehicle management device can maintain the ECU in the active state by transmitting the start instruction signal to the ECU that has switched to the active state. On the other hand, when the relay is erroneously switched to the ON state, the start instruction signal is not transmitted from the in-vehicle management device to the ECU. In this case, the ECU transmits the shut-off permission signal to the in-vehicle management device after the determination time has elapsed after the ECU has switched to the active state. As a result, the relay is switched to the OFF state by the in-vehicle management device, and the ECU turns to the power-OFF state. Therefore, when the relay is erroneously switched to the ON state, the in-vehicle system can switch the ECU to the power-OFF state, and as a result, wasteful power consumption of the ECU can be reduced.

In a second aspect, the in-vehicle system according to the first aspect, wherein when not receiving the start instruction signal within the determination time, the ECU transmits the shut-off permission signal to the in-vehicle management device and then shifts to a sleep state.

There may be a case where the relay that has been erroneously switched to the ON state does not return to the OFF state. Even in such a case, the ECU shifts to the sleep state in which power consumption is lower, and hence the power consumption can be reduced.

In a third aspect, the in-vehicle system according to the first or the second aspect, wherein when receiving the shut-off permission signal, the in-vehicle management device switches the relay to the OFF state on condition that it is determined that the relay is in a state where the relay can be switched to the OFF state based on a vehicle state.

The shut-off permission signal may be erroneously transmitted from the ECU. Even in this case, the in-vehicle management device switches the relay to the OFF state on condition that it is determined that the relay is in a state where the relay can be switched to the OFF state based on the vehicle state. This makes it easier to avoid switching the relay to the OFF state in a situation where the relay should not be switched to the OFF state.

In a fourth aspect, the in-vehicle system according to any one of the first to the third aspects, wherein the in-vehicle management device includes a first control unit configured to control the relay and a second control unit configured to communicate with the ECU, and the first control unit and the second control unit are configured to be able to operate independently of each other.

In the in-vehicle system, even if the first control unit fails, the second control unit can shift the ECU to the sleep state, and even if the second control unit fails, the first control unit can switch the relay to the OFF state.

In a fifth aspect, an ECU configured to be switched to an active state when receiving power supply, maintain the active state when receiving a start instruction signal from an in-vehicle management device within a determination time after having switched to the active state, and shift to a sleep state when not receiving the start instruction signal within the determination time.

Even if the ECU has switched to the active state due to the relay being erroneously switched to the ON state, the ECU shifts to the sleep state by not receiving the start instruction signal. Thus, wasteful power consumption of the ECU is reduced.

### First Embodiment

1-1. Configuration of in-Vehicle System 1

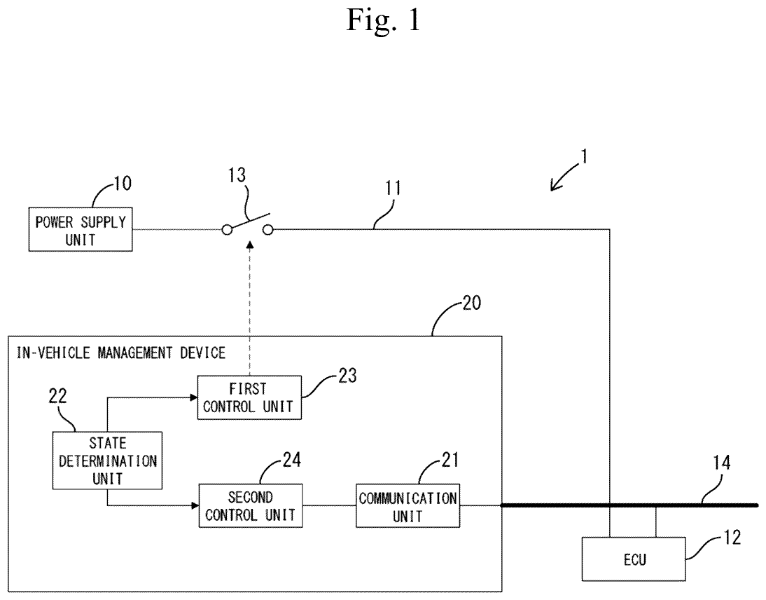

An in-vehicle system 1 of a first embodiment illustrated in FIG. 1 is a system mounted on a vehicle. The in-vehicle system 1 includes a power supply unit 10, a power path 11, an ECU 12, a relay 13, a bus 14, and an in-vehicle management device 20.

The power supply unit 10 is configured by including, for example, a battery. The power supply unit 10 may include, for example, a low-voltage battery, or may include a high-voltage battery and a DC-DC converter that steps down an output voltage of the high-voltage battery.

The power path 11 is an electric path that supplies power from the power supply unit 10 to the ECU 12.

The ECU 12 is an electronic control unit. The ECU 12 is electrically connected to the power path 11.

The relay 13 may be configured by a mechanical switch or may be configured by a semiconductor switch. The relay 13 is provided between the power supply unit 10 and the ECU 12 on the power path 11. The relay 13 switches a power supply state to the ECU 12. Specifically, the relay 13 allows power supply from the power supply unit 10 to the ECU 12 in the ON state, and shuts off power supply from the power supply unit 10 to the ECU 12 in the OFF state. That is, power is supplied to the ECU 12 when the relay 13 is in the ON state, and power supply to the ECU 12 is shut off when the relay 13 is in the OFF state.

The in-vehicle management device 20 is a device configured to manage a power supply state of the ECU 12. The in-vehicle management device 20 includes a communication unit 21, a state determination unit 22, a first control unit 23, and a second control unit 24.

The communication unit 21 is configured by, for example, a communication interface. The communication unit 21 is a communication interface for the in-vehicle management device 20 to communicate with the ECU 12 via the bus 14. The communication unit 21 is, for example, a transceiver, more specifically, a CAN transceiver.

The state determination unit 22, the first control unit 23, and the second control unit 24 can operate independently of each other.

For example, the state determination unit 22, the first control unit 23, and the second control unit 24 are configured as separate control circuits each including a microcomputer.

The state determination unit 22 determines a vehicle state based on various types of information input to itself. The state determination unit 22 transmits state information indicating the determined vehicle state to the first control unit 23 and the second control unit 24.

The first control unit 23 determines whether or not the start condition is satisfied based on the state information received from the state determination unit 22, and switches the relay 13 to the ON state when determining that the start condition is satisfied. The first control unit 23 stores, for example, a table indicating a correspondence relationship between a vehicle state and an ON/OFF state of its own control target (e.g., the relay 13). The first control unit 23 determines a control target to be set to the ON state based on the table and the vehicle state. Determining the control target to be set to the ON state in this manner corresponds to determining that the start condition for the control target is satisfied.

The second control unit 24 can communicate with the ECU 12 via the bus 14. The second control unit 24 determines whether or not the start condition is satisfied based on the state information received from the state determination unit 22, and transmits a start instruction signal to the ECU 12 via the bus 14 when determining that the start condition is satisfied. The second control unit 24 determines whether or not the start condition is satisfied, for example, similarly to the first control unit 23 described above.

The second control unit 24 transmits a start instruction signal at a timing when the ECU 12 is switched to the active state and can receive a signal.

When the relay 13 is in the OFF state, no power is supplied, and thus the ECU 12 is in the power-OFF state. When the relay 13 is switched to the ON state, the ECU 12 receives power supply from the power path 11 and switches to the power-ON state. In the power-ON state, the ECU 12 shifts to an active state and a sleep state. The sleep state is a state in which power consumption is lower than that in the active state. The ECU 12 switches to the active state when the relay 13 is switched to the ON state. The ECU 12 maintains the active state when receiving the start instruction signal within a predetermined determination time, and transmits a shut-off permission signal to the second control unit 24 when not receiving the start instruction signal within the determination time. When not receiving the start instruction signal within the determination time, the ECU 12 transmits the shut-off permission signal to the second control unit 24, and then shifts to the sleep state.

When receiving the shut-off permission signal, the second control unit 24 transmits the shut-off permission signal to the state determination unit 22. When receiving the shut-off permission signal, the state determination unit 22 transmits the shut-off permission signal to the first control unit 23. When receiving the shut-off permission signal, the first control unit 23 determines whether or not the relay 13 is in a state where the relay 13 can be switched to the OFF state based on the state information. For example, when the relay 13 is in a state where it should be set to the OFF state based on the table and the vehicle state described above, the first control unit 23 determines that the relay 13 is in a state where the relay 13 can be switched to the OFF state. When determining the relay 13 is in a state where the relay 13 can be switched to the OFF state, the first control unit 23 switches the relay 13 to the OFF state.

1-2. Example of Operation of in-Vehicle Management Device 20

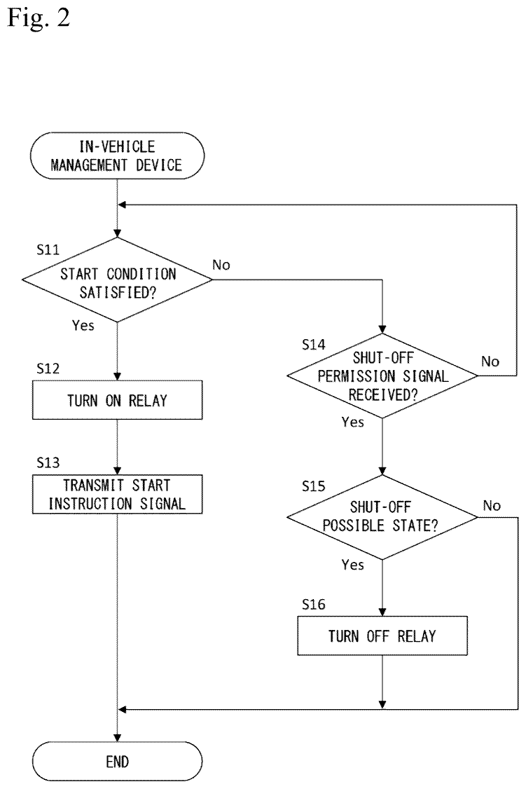

The in-vehicle management device 20 performs, for example, the processing illustrated in FIG. 2. In step S11, the in-vehicle management device 20 determines whether or not a predetermined start condition is satisfied. When determining that the start condition is not satisfied, the in-vehicle management device 20 determines in step S14 whether or not the shut-off permission signal has been received. When determining that the shut-off permission signal has not been received, the in-vehicle management device 20 returns to the processing of step S11. That is, the in-vehicle management device 20 repeats the processing of step S11 and the processing of step S14 until the start condition is satisfied or the shut-off permission signal has been received.

When determining that the start condition is satisfied in step S11, the in-vehicle management device 20 switches the relay 13 to the ON state in step S12, and transmits a start instruction signal to the ECU 12 in step S13. Thereafter, the processing illustrated in FIG. 2 is ended.

When determining in step S14 that the shut-off permission signal has been received, the in-vehicle management device 20 determines in step S15 whether or not it is in a state where shut-off is possible. When determining to be it is in a state where shut-off is not possible, the in-vehicle management device 20 ends the processing illustrated in FIG. 2 without switching the relay 13 to the OFF state. When determining it is in a state shut-off is possible, the in-vehicle management device 20 switches the relay 13 to the OFF state in step S16, and ends the processing illustrated in FIG. 2. The in-vehicle management device 20 repeatedly executes the processing illustrated in FIG. 2 by restarting immediately after ending the processing illustrated in FIG. 2.

### 1-3. Example of Operation of ECU 12

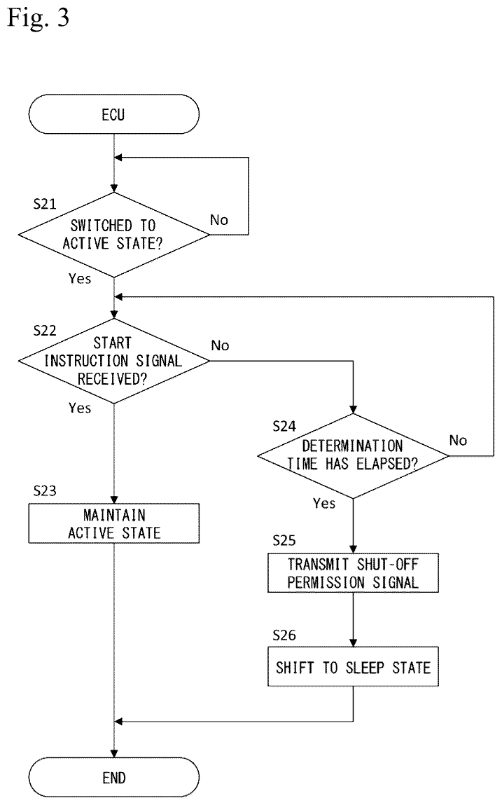

When receiving the power supply from the power path 11, the ECU 12 starts, for example, the processing illustrated in FIG. 3. In step S21, the ECU 12 determines whether or not the ECU 12 has switched to the active state. The ECU 12 repeats the processing of step S21 until the ECU 12 has switched to the active state. When determining that the ECU 12 has switched to the active state, the ECU 12 determines in step S22 whether or not the start instruction signal has been received. When determining that the start instruction signal has not been received, the ECU 12 determines in step S2i4 whether or not a determination time has elapsed after having switched to the active state. When determining that the determination time has not elapsed, the ECU 12 returns to the processing of step S22. That is, the ECU 12 repeats the processing of step S22 and the processing of step S24 until the start instruction signal has been received or the determination time has elapsed. When determining that the start instruction signal has been received, the ECU 12 ends the processing illustrated in FIG. 3 while maintaining the active state in step S23. When determining that the determination time has elapsed, the ECU 12 transmits the shut-off permission signal to the in-vehicle management device 20 in step S25, and shifts to the sleep state in step S26. Thereafter, the ECU 12 ends the processing illustrated in FIG. 3.

1-4. Example of Operation and Effect of in-Vehicle System 1

The in-vehicle system 1 includes the ECU 12 mounted on a vehicle and the in-vehicle management device 20 capable of communicating with the ECU 12. When the start condition is satisfied, the in-vehicle management device 20 switches the relay 13 which switches the power supply state to the ECU 12, to the ON state, and transmits the start instruction signal to the ECU 12. When the relay 13 is switched to the ON state, the ECU 12 receives power supply and switches from the power-OFF state to the active state. The ECU 12 maintains the active state when receiving the start instruction signal within the determination time after having switched to the active state, and transmits the shut-off permission signal to the in-vehicle management device 20 when not receiving the start instruction signal within the determination time. When receiving the shut-off permission signal, the in-vehicle management device 20 switches the relay 13 to the OFF state.

The in-vehicle system 1 can supply power to the ECU 12 by switching the relay 13 to the ON state when the start condition is satisfied, and can switch the ECU 12 from the power-OFF state to the active state. Furthermore, the in-vehicle management device 20 can maintain the ECU 12 in the active state by transmitting the start instruction signal to the ECU 12 that has switched to the active state. On the other hand, when the relay 13 is erroneously switched to the ON state, the start instruction signal is not transmitted from the in-vehicle management device 20 to the ECU 12. In this case, the ECU 12 transmits the shut-off permission signal to the in-vehicle management device 20 after the determination time has elapsed after the ECU 12 has switched to the active state. As a result, the relay 13 is switched to the OFF state by the in-vehicle management device 20, and the ECU 12 turns to the power-OFF state. Therefore, when the relay 13 is erroneously switched to the ON state, the in-vehicle system 1 can switch the ECU 12 to the power-OFF state, and as a result, wasteful power consumption of the ECU 12 can be reduced.

When not receiving the start instruction signal within the determination time, the ECU 12 transmits the shut-off permission signal to the in-vehicle management device 20, and then shifts to the sleep state. There may be a case where the relay 13 that has been erroneously switched to the ON state does not return to the OFF state. For example, in a case where an ON-failure in which the relay 13 is stuck in the ON state occurs, the relay 13 does not return to the OFF state. Even in such a case, the ECU 12 shifts to the sleep state in which power consumption is lower, and hence the power consumption can be reduced.

When receiving the shut-off permission signal, the in-vehicle management device 20 switches the relay 13 to the OFF state on condition that it is determined that the relay 13 is in a state where the relay 13 can be switched to the OFF state based on the vehicle state. The shut-off permission signal may be erroneously transmitted from the ECU 12. Even in this case, the in-vehicle management device 20 switches the relay 13 to the OFF state on condition that it is determined that the relay 13 is in a state where the relay 13 can be switched to the OFF state based on the vehicle state. This makes it easier to avoid switching the relay 13 to the OFF state in a situation where the relay 13 should not be switched to the OFF state.

The in-vehicle management device 20 includes the first control unit 23 configured to control the relay 13 and the second control unit 24 configured to communicate with the ECU 12, and the first control unit 23 and the second control unit 24 are configured to be able to operate independently of each other. According to this configuration, in the in-vehicle system 1, even if the first control unit 23 fails, the second control unit 24 can shift the ECU 12 to the sleep state, and even if the second control unit 24 fails, the first control unit 23 can switch the relay 13 to the OFF state.

### OTHER EMBODIMENTS

The present disclosure is not limited to the embodiments described with reference to the above description and drawings. For example, the features of the embodiments described above or below can be combined in any manner to the extent that they do not contradict each other. In addition, any of the features of the embodiments described above or below can be omitted unless clearly indicated as being essential. Furthermore, the embodiment described above may be modified as follows.

The ECU may not shift to the sleep state after transmitting the shut-off permission signal.

Regardless of the vehicle state, the in-vehicle management device 20 may switch the relay to the OFF state when receiving the shut-off permission signal.

The state determination unit, the first control unit, and the second control unit may not be able to operate independently of each other. For example, the state determination unit, the first control unit, and the second control unit may be configured by a control circuit including one microcomputer.

It should be considered that the embodiment disclosed herein is illustrative and not restrictive in all respects. The scope of the present disclosure is not limited to the embodiment disclosed herein, but is indicated by the Claims, and is intended to include all modifications within the meaning and scope equivalent to the Claims.

What is claimed is:

1. An in-vehicle system comprising:
an ECU mounted on a vehicle; and
an in-vehicle management device capable of communicating with the ECU; wherein
when a start condition is satisfied, the in-vehicle management device switches a relay that switches a power supply state to the ECU, to an ON state, and transmits a start instruction signal to the ECU,
when the relay is switched to the ON state, the ECU receives power supply switches from a power-OFF state to an active state, the ECU maintains the active state when receiving the start instruction signal within a determination time after having switched to the active state, and transmits a shut-off permission signal to the in-vehicle management device when not receiving the start instruction signal within the determination time, and
when receiving the shut-off permission signal, the in-vehicle management device switches the relay to an OFF state.

2. The in-vehicle system according to claim 1, wherein when not receiving the start instruction signal within the determination time, the ECU transmits the shut-off permission signal to the in-vehicle management device and then shifts to a sleep state.

3. The in-vehicle system according to claim 1, wherein when receiving the shut-off permission signal, the in-vehicle management device switches the relay to the OFF state on condition that it is determined that the relay is in a state where the relay can be switched to the OFF state based on a vehicle state.

4. The in-vehicle system according to claim 1, wherein
the in-vehicle management device includes a first control unit configured to control the relay and a second control unit configured to communicate with the ECU; and
the first control unit and the second control unit are configured to be able to operate independently of each other.

5. The in-vehicle system according to claim 2, wherein when receiving the shut-off permission signal, the in-vehicle management device switches the relay to the OFF state on condition that it is determined that the relay is in a state where the relay can be switched to the OFF state based on a vehicle state.

6. The in-vehicle system according to claim 2, wherein
the in-vehicle management device includes a first control unit configured to control the relay and a second control unit configured to communicate with the ECU; and
the first control unit and the second control unit are configured to be able to operate independently of each other.

7. An ECU configured to be switched to an active state when receiving power supply, maintain the active state when receiving a start instruction signal from an in-vehicle management device within a determination time after having switched to the active state, and shift to a sleep state when not receiving the start instruction signal within the determination time.
